(19) United States
(12) Patent Application Publication
(10) Pub. No.: US 2020/0137644 A1
(43) Pub. Date: Apr. 30, 2020

(54) WIRELESS BASE STATION AND HANDOVER METHOD THEREOF

(71) Applicant: INDUSTRIAL TECHNOLOGY RESEARCH INSTITUTE, Hsinchu (TW)

(72) Inventor: Chang-Kuo YEH, Hsinchu City (TW)

(73) Assignee: INDUSTRIAL TECHNOLOGY RESEARCH INSTITUTE, Hsinchu (TW)

(21) Appl. No.: 16/231,739

(22) Filed: Dec. 24, 2018

(30) Foreign Application Priority Data
Oct. 29, 2018 (TW) 107138248

(51) Int. Cl. H04W 36/00; H04W 36/14; H04W 8/26; H04W 76/19; H04W 80/08

(52) U.S. Cl. CPC H04W 36/0066; H04W 36/14; H04W 80/08; H04W 76/19; H04W 8/26

(57) ABSTRACT

A wireless base station is wireless communicating with a user equipment (UE) and exchanging information with a target base station. A handover method for the a wireless base station includes: sending by the wireless base station to a UE a first reconfiguration message which includes a PDCP reconfiguration message to change a PDCP SN length of the UE to a predetermined bit length; after sending the first reconfiguration message, sending by the wireless base station a handover request message or a handover required message to inform the target base station and receiving a handover request acknowledge message or a handover command message; and after receiving the handover request acknowledge message or the handover command message, sending by the wireless base station a second reconfiguration message to the UE, wherein the second reconfiguration message includes a handover message.

### CROSS-REFERENCE TO RELATED ART

This application is based on, and claims priority from Taiwan application Serial No. 107138248, filed Oct. 29, 2018. The disclosure of which is incorporated by reference herein in its entirety.

### TECHNICAL FIELD

The disclosure is directed to a wireless base station and a handover method thereof.

### BACKGROUND

In a wireless communication system, due to develop of different standard versions, the length of a PDCP (packet data convergence protocol) SN (serial number) is also different. For example, in 3GPP release 8, the PDCP SN has 12-bit length; in 3GPP release 11, the PDCP SN has 15-bit length and in 3GPP release 13, the PDCP SN has 18-bit length.

It is important to have a UE (user equipment) handover procedure. During the handover procedure, usually, the target base station will not change the PDCP SN length of the UE.

If the PDCP SN length of the target base station is different from the PDCP SN length of the UE, after handover, data service provided to UE may have some problems. For example, if the UE supports 15-bit or 18-bit PDSN SN length, then the source base station may configure the PDCP SN length of the UE as 15 bits or 18 bits. During handover procedure, if the target base station just supports 12-bit PDCP SN length, then the target base station cannot configure the PDCP SN length of the UE as 15 bits. Thus, after the UE is handed over to the target base station, the data service provided to the UE may have problems due to the difference between the PDCP SN length of the target base station and the PDCP SN length of the UE.

Thus, there needs a wireless base station and the handover method therefor which may prevent the conventional handover problems.

### SUMMARY

According to one exemplary embodiment, this disclosure is a handover method for a wireless base station, the wireless base station being configured for wireless communicating with a user equipment (UE) and exchanging message with a target base station. The handover method includes: sending, by the wireless base station, a first reconfiguration message to the UE, wherein the first reconfiguration message includes a Packet Data Convergence Protocol (PDCP) reconfiguration message for changing a PDCP Sequence Number (SN) length of the UE to a predetermined bit length; after sending the first reconfiguration message, sending, by the wireless base station, a handover request message or a handover required message to inform the target base station, and receiving a handover request acknowledge message or a handover command message by the wireless base station; and after receiving the handover request acknowledge message or the handover command message by the wireless base station, sending, by the wireless base station, a second reconfiguration message to the UE, wherein the second reconfiguration message includes a handover message.

According to another exemplary embodiment, the disclosure is a handover method for a wireless base station, the wireless base station being configured for wireless communicating with a user equipment (UE) and exchanging message with a target base station. The handover method includes: sending, by the wireless base station, a handover request message or a handover required message to inform the target base station that the UE does not used an extended Sequence Number (SN) length in a PDCP layer and to inform the target base station that the UE has a candidate DRB ID; receiving a handover request acknowledge message or a handover command message by the wireless base station, and based on the handover request acknowledge message or the handover command message, determining by the wireless base station whether a DRB resource of the UE is released or not and whether a configuration of the UE is reset or not; and when the wireless base station determines that the DRB resource of the UE is not released and that the configuration of the UE is not reset, sending by the wireless base station a first reconfiguration message to the UE for changing a PDCP SN length of the UE to a predetermined bit length and for changing a DRB ID of the UE as the candidate DRB ID, wherein the first reconfiguration message includes a PDCP reconfiguration message and a handover message.

According to yet another exemplary embodiment, the disclosure is a wireless base station exchanging message with a target base station, the wireless base station including: at least one antenna for wireless communication with a user equipment (UE) and the target base station; and a controller coupled to the at least one antenna, the controller being configured for: controlling the at least one antenna to send a first reconfiguration message to the UE, wherein the first reconfiguration message includes a Packet Data Convergence Protocol (PDCP) reconfiguration message for changing a PDCP Sequence Number (SN) length of the UE to a predetermined bit length; after controlling the at least one antenna to send the first reconfiguration message, controlling the at least one antenna to send a handover request message or a handover required message to inform the target base station, and to receive a handover request acknowledge message or a handover command message; and after controlling the at least one antenna to receive the handover request acknowledge message or the handover command message, controlling the at least one antenna to send a second reconfiguration message to the UE, wherein the second reconfiguration message includes a handover message.

According to an alternative exemplary embodiment, the disclosure is a wireless base station being configured for exchanging message with a target base station, the wireless base station including: at least one antenna for wireless communicating with a user equipment (UE) and the target base station; and a controller coupled to the at least one antenna, the controller being configured for: controlling the at least one antenna to send a handover request message or a handover required message to inform the target base station that the UE does not used an extended Sequence Number (SN) length in a PDCP layer and to inform the target base station that the UE has a candidate DRB ID; controlling the at least one antenna to receive a handover request acknowledge message or a handover command message, and based on the handover request acknowledge message or the handover command message, determining whether a DRB resource of the UE is released or not and whether a configuration of the UE is reset or not; and when the controller determines that the DRB resource of the UE is not released and that the configuration of the UE is not reset, controlling the at least one antenna to send a first reconfiguration message to the UE for changing a PDCP SN length of the UE to a predetermined bit length and for changing a DRB ID of the UE as the candidate DRB ID, wherein the first reconfiguration message includes a PDCP reconfiguration message and a handover message.

### BRIEF DESCRIPTION OF THE DRAWINGS

FIG. 1 shows a handover flow chart according to an exemplary embodiment of the application.

FIG. 2 shows a handover flow chart according to an exemplary embodiment of the application.

FIG. 3 shows a functional block diagram of a wireless base station according to an exemplary embodiment of the application.

FIG. 4 shows a handover flow chart according to an exemplary embodiment of the application.

FIG. 5 shows a handover flow chart according to an exemplary embodiment of the application.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

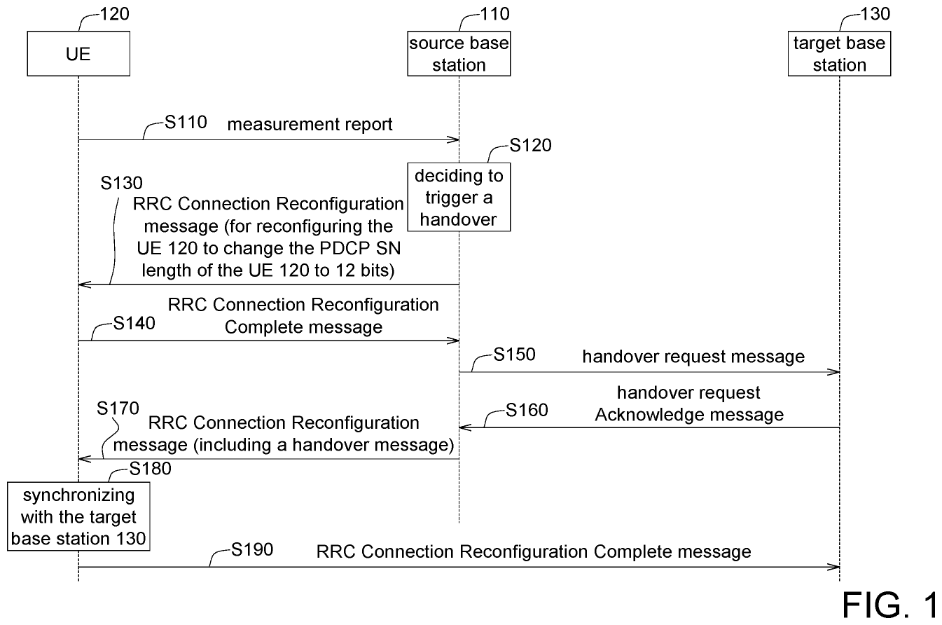

FIG. 1 shows a handover flow chart according to an exemplary embodiment of the application. FIG. 1 is applicable in a wireless communication system including: a source base station 110, a user equipment (UE) 120 and a target base station 130. The source base station 110, the UE 120 and the target base station 130 may exchange message with each other. The UE 120 is configured with PDCP SN length larger than 12 bits, for example, the PDCP SN length being 15 bits or 18 bits. The source base station 110 supports 12-bit, 15-bit or 18-bit PDCP SN length. The target base station 130 supports 12-bit PDCP SN length but does not support 15-bit or 18-bit PDCP SN length. In FIG. 1, the source base station 110 supports the extended PDCP-SN length while the target base station 130 does not support the extended PDCP-SN length. That is the target base station 130 only supports the legacy PDCP-SN length.

In step S110, the UE 120 sends a measurement report to the source base station 110.

In step S120, based on the measurement report, the source base station 110 decides to indicate the UE 120 to handover to the target base station 130.

In step S130, if the source base station 110 determines that the PDCP SN length of the UE 120 is larger than the 12 bit length, then the source base station 110 sends a Radio Resource Control (RRC) Connection Reconfiguration message (including a PDCP reconfiguration message) to the UE 120 for reconfiguring the UE 120 to change the PDCP SN length of the UE 120 from 15 bits (or 18 bits) to 12 bits. In the following, the 12 bits is also referred as a predetermined bit length.

In an exemplary embodiment of the application, changing the PDCP SN length of the UE 120 from 15 bits (or 18 bits) to 12 bits by the source base station 110 may include, for example but not limited by, that the source base station 110 informs the UE 120 and the UE 120 releases the Data Radio Bearer (DRB) resource and re-establishes the DRB resource based on the RRC Connection Reconfiguration message. The DRB ID which the UE 120 uses in re-establishing the DRB resource may be the same or different from the old DRB ID, but the UE 120 will use the same Evolved Packet System (EPS) EPS bearer ID in re-establishing the DRB resource. Of course, in other possible exemplary embodiment of the application, changing the PDCP SN length of the UE 120 from 15 bits (or 18 bits) to 12 bits by the source base station 110 may have other possible implementation and the application is not limited by this.

In step S140, the UE 120 sends a RRC Connection Reconfiguration Complete message to the source base station 110.

In step S150, the source base station 110 sends a handover request message to the target base station 130 to begin the handover procedure.

In step S160, the target base station 130 sends a handover request Acknowledge message to the source base station 110.

In step S170, the source base station 110 sends a RRC Connection Reconfiguration message (including a handover message) to the UE 120.

In step S180, the UE 120 synchronizes to the target base station 130.

In step S190, the UE 120 sends a RRC Connection Reconfiguration Complete message to the target base station 130. The handover procedure is totally completed.

In other words, in the exemplary embodiment in FIG. 1, before performing the handover procedure (step S170), the source base station 110 downgrades the PDCP SN length of the UE 120 as 12 bits (in step S130).

From the above description, in the exemplary embodiment of FIG. 1, the source base station 110 downgrades the PDCP SN length of the UE 120 as 12 bits (the target base station 130 also supports 12-bit PDCP SN length). After the handover procedure, the UE 120 and the target base station 130 use the same PDCP SN length (both as 12 bits). Thus, data service provided to the UE 120 has no problem in the exemplary embodiment of the application. The exemplary embodiment of the application prevents UE data service interruption problems in the conventional art which is caused by the difference between the PDCP SN length of the UE and the PDCP SN length of the target base station.

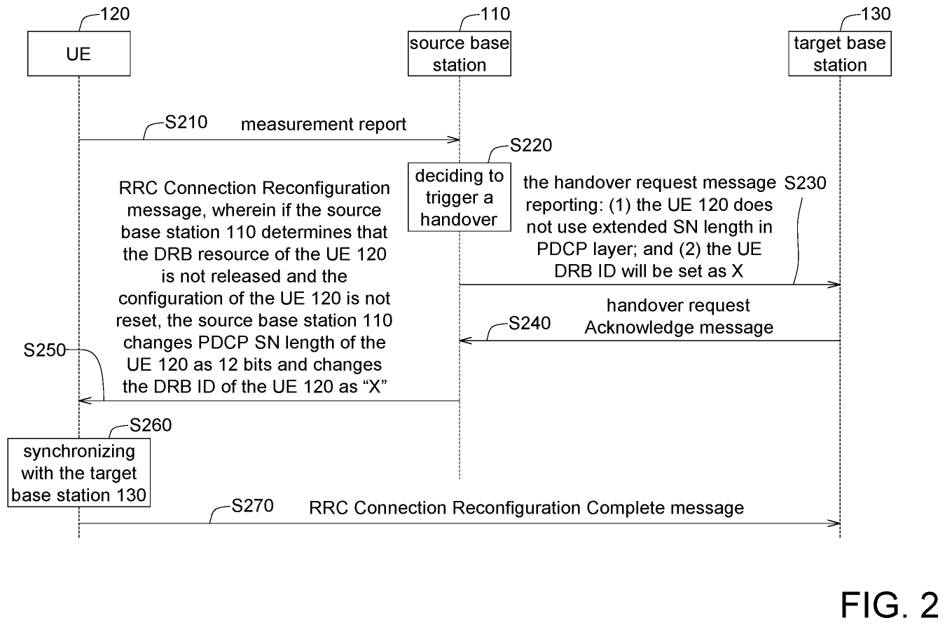

FIG. 2 shows a handover flow chart according to an exemplary embodiment of the application. Similarly, in FIG. 2, the UE 120 is configured with the PDCP SN length larger than 12 bits, for example being 15 bits or 18 bits. The source base station 110 supports 12-bit, 15-bit or 18-bit PDCP SN length. But the target base station 130 supports neither 15-bit nor 18-bit PDCP SN length. In fact, the target base station 130 supports 12-bit PDCP SN length. That is the target base station 130 only supports the legacy PDCP-SN length.

In step S210, the UE 120 sends a measurement report to the source base station 110.

In step S220, based on the measurement report, the source base station 110 decides to indicate the UE 120 to handover to the target base station 130.

In step S230, the source base station 110 sends a handover request message to the target base station 130 to begin the handover procedure. Via the handover request message, the source base station 110 reports to the target base station 130 about: (1) the UE 120 does not use extended SN length in PDCP layer (i.e. the UE DRB will be not set as 15-bit or 18-bit PDCP SN length, the UE DRB will be set as 12-bit PDCP SN length, and the current UE DRB is still set as 15-bit or 18-bit PDCP SN length); and (2) the UE DRB ID will be set as X (X being the same or different from the current UE DRB ID, in the following, “X” also referring as “candidate DRB ID”).

In step S240, the target base station 130 sends a handover request Acknowledge message to the source base station 110.

In step S250, the source base station 110 sends a RRC Connection Reconfiguration message to the UE 120, wherein based on the handover request Acknowledge message from the target base station 130, the source base station 110 determines that whether the DRB resource of the UE 120 is released or not and whether the configuration of the UE 120 is reset or not. Based on the handover request Acknowledge message from the target base station 130, if the source base station 110 determines that the DRB resource of the UE 120 is not released and the configuration of the UE 120 is not reset, the source base station 110 sends the RRC Connection Reconfiguration message to the UE 120 to change PDCP SN length of the UE 120 as 12 bits (similar to those details in the exemplary embodiment in FIG. 1) and the source base station 110 changes the DRB ID of the UE 120 as the candidate DRB ID (i.e. changing the DRB ID of the UE 120 as “X” in step S230). The source base station 110 determines whether the DRB resource of the UE 120 is released or not based on: the source base station 110 determining whether the PDCP resource of the UE 120 is released or not. Further, the source base station 110 determines that the DRB resource of the UE 120 is released or not based on: the source base station 110 determining whether the RRC E-UTRA handover command within the handover request acknowledge message including drb-ToReleaseList IE or not. The source base station 110 determines that whether the configuration of the UE 120 is reset based on: the source base station 110 determining whether the RRC E-UTRA handover command within the handover request acknowledge message from the target base station 130 including fullConfig-r9 IE. Of course, the application is not limited by this. Similarly, in step S250, the RRC Connection Reconfiguration message from the source base station 110 to the UE 120 includes PDCP reconfiguration message and the handover message, wherein the PDCP reconfiguration message is used in reconfiguring the UE to downgrade the PDCP SN length of the UE from 15 bits (or 18 bits) as 12 bits.

In step S260, the UE 120 synchronizes to the target base station 130.

In step S270, the UE 120 sends the RRC Connection Reconfiguration Complete message to the target base station 130. By so, the handover procedure is completed.

In the exemplary embodiment in FIG. 2, during the handover procedure, the source base station 110 downgrades the PDCP SN length of the UE 120 as 12 bits.

From the above description, in the exemplary embodiment of FIG. 2, because the source base station 110 downgrades the PDCP SN length of the UE 120 as 12 bits (the target base station 130 also supports the 12-bit PDCP SN length, i.e. the target base station 130 only supports the legacy PDCP-SN length), after the handover procedure, the UE 120 and the target base station 130 use the same PDCP SN length (both as 12 bits). Thus, the data service provided to the UE 120 has no problem in the exemplary embodiment of the application. The exemplary embodiment of the application prevents UE data service interruption problems in the conventional art which is caused by the difference between the PDCP SN length of the UE and the PDCP SN length of the target base station.

Further, in the above two exemplary embodiments of the application, the behavior and the version of the target base station 130 will be not limited because the target base station 130 may be implemented by the wireless base station which supports old versions.

Further, the above two exemplary embodiments of the application are compatible 3GPP R12, R13, R14 and R15.

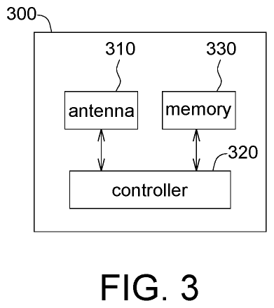

FIG. 3 shows a functional block diagram of a wireless base station according to an exemplary embodiment of the application. The wireless base station 300 may be used in implementing the source base station 110 in FIG. 1 and FIG. 2. The wireless base station 300 may exchange messages with other wireless base stations. The wireless base station 300 includes: an antenna 310, a controller 320 and a memory 330. The antenna 310 may be in communication with the UE. The controller 320 controls the antenna 310 and the memory 330. Further, the controller 320 controls the wireless base station 300 to implement the handover procedure in FIG. 1 and FIG. 2. The memory 330 is used for storing setting parameter and so on. It should be noted that for some communication systems, the number of antenna could be more than one.

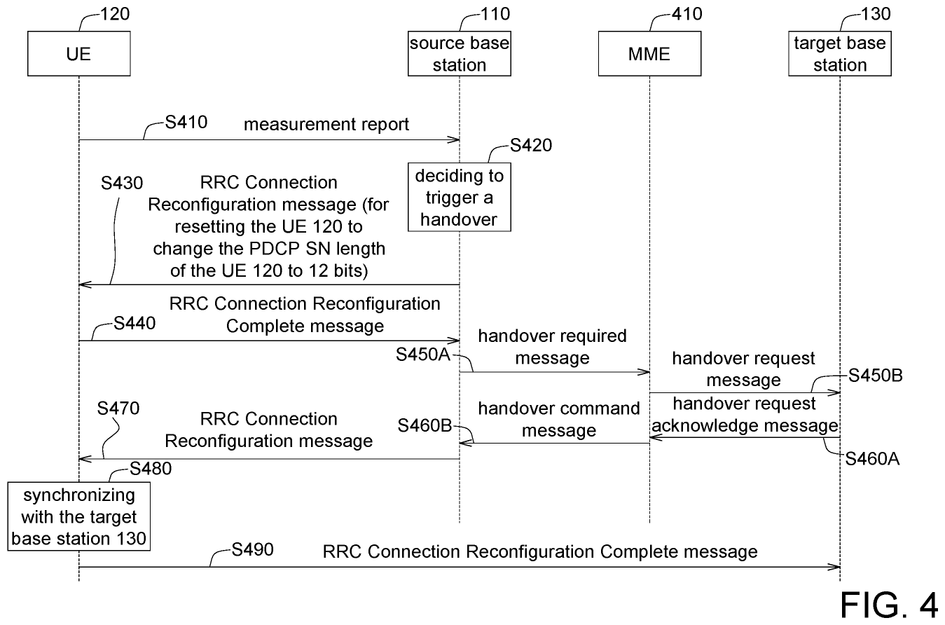

FIG. 4 shows a handover flow chart according to an exemplary embodiment of the application. FIG. 4 is used in a wireless communication system which includes the source base station 110, the UE 120, the target base station 130 and a Mobility Management Entity (MME) 410. The UE 120, the source base station 110, the target base station 130 and the MME 410 may exchange messages with each other. The MME 410 is for movement management when the UE is in idle mode, EPS barrier management and Non-access Stratum (NAS) management.

The steps S410, S420, S430, S440, S470, S480 and S490 in FIG. 4 may the same or similar to the steps S110, S120, S130, S140, S170, S180 and S190 in FIG. 1 and thus the details are omitted here.

In step S450A, the source base station 110 sends a handover required message to the MME 410 to begin the handover procedure. In step S450B, the MME 410 sends a handover request message to the target base station 130.

In step S460A, the target base station 130 sends a handover request acknowledge message to the MME 410. In step S460B, the MME 410 sends a handover command message to the source base station 110.

Thus, in the embodiment of FIG. 4, before the handover procedure (step S470), the source base station 110 downgrades the PDCP SN length of the UE 120 as 12 bits (in step S430).

From the above description, in the exemplary embodiment of FIG. 4, because the source base station 110 downgrades the PDCP SN length of the UE 120 as 12 bits (the target base station 130 also supports the 12-bit PDCP SN length, i.e. the target base station 130 only supports the legacy PDCP-SN length), after the handover procedure, the UE 120 and the target base station 130 have the same PDCP SN length (both as 12 bits). Thus, the data service provided to the UE 120 has no problem in the exemplary embodiment of the application. The exemplary embodiment of the application prevents UE data service interruption problems in the conventional art which is caused by the difference between the PDCP SN length of the UE and the PDCP SN length of the target base station.

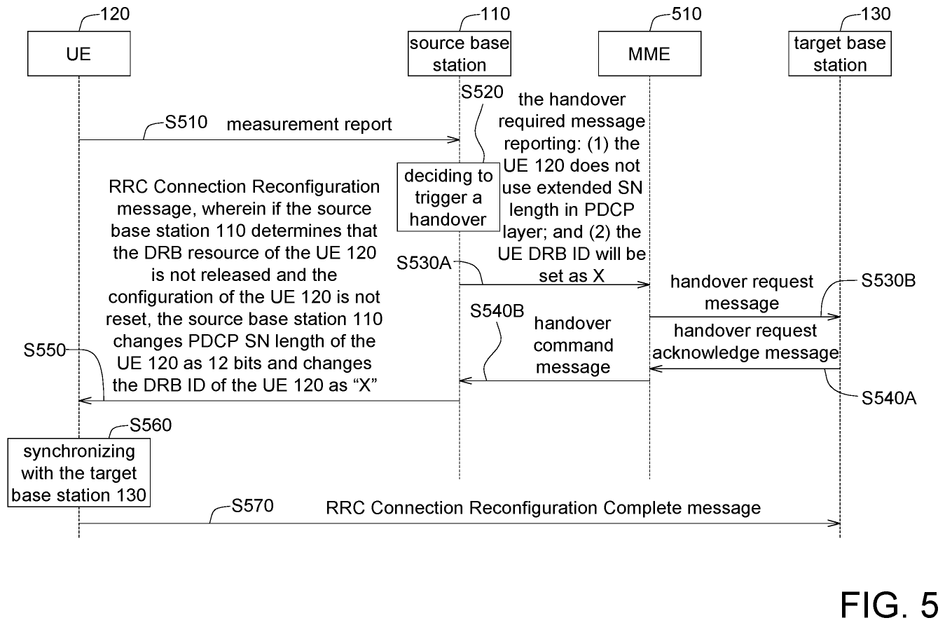

FIG. 5 shows a handover flow chart according to an exemplary embodiment of the application. FIG. 5 is applicable in a wireless communication system including: the source base station 110, the UE 120, the target base station 130 and the MME 510.

Steps S510, S520, S550, S560 and S570 in FIG. 5 are the same or similar to the steps S210, S220, S250, S260 and S270 in FIG. 2 and thus the details are omitted here.

In step S530A, the source base station 110 sends a handover required message to the MME 510 to begin the handover procedure. In step S530B, the MME 510 sends the handover request message to the target base station 130. After steps 530A and 530B, the target base station 130 knows that: (1) the UE 120 does not use extended SN length in PDCP layer (i.e. the UE DRB will be not set as 15-bit or 18-bit PDCP SN length, the UE DRB will be set as 12-bit PDCP SN length, and the current UE DRB is still set as 15-bit or 18-bit PDCP SN length); and (2) the UE DRB ID will be set as X (X being the same or different from the current UE DRB ID).

In step S540A, the target base station 130 sends a handover request acknowledge message to the MME 510. In step S540B, the MME 510 sends a handover command message to the source base station 110.

Thus, in the exemplary embodiment of FIG. 5, during the handover procedure (in step S550), the source base station 110 downgrades the PDCP SN length of the UE 120 as 12 bits. Similarly, in step S550, based on whether the RRC E-UTRA handover command within the handover command message from the MME 510 includes drb-ToReleaseList IE, the source base station 110 determines whether the DRB resource of the UE 120 is released or not. Further, the source base station 110 determines whether the UE 120 is reset based on: whether the RRC E-UTRA handover command within the handover command message from the MME 510 includes fullConfig-r9 IE or not.

From the above description, in the exemplary embodiment of FIG. 5, because the source base station 110 downgrades the PDCP SN length of the UE 120 as 12 bits (the target base station 130 also supports the 12-bit PDCP SN length), after the handover procedure, the UE 120 and the target base station 130 use the same PDCP SN length (both as 12 bits). Thus, the data service provided to the UE 120 has little problem in the exemplary embodiment of the application. The exemplary embodiment of the application prevents UE data service interruption problems in the conventional art which is caused by the difference between the PDCP SN length of the UE and the PDCP SN length of the target base station.

In FIG. 4 and FIG. 5, message exchange between the source base station 110 and the target base station 130 is through the MME 410 or the MME 510. Besides, the wireless base station 300 in FIG. 3 may be used to implement the source base station 110 in FIG. 4 and FIG. 5.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A handover method for a wireless base station, the wireless base station being configured for wireless communicating with a user equipment (UE) and exchanging message with a target base station, the handover method including:
sending, by the wireless base station, a first reconfiguration message to the UE, wherein the first reconfiguration message includes a Packet Data Convergence Protocol (PDCP) reconfiguration message for changing a PDCP Sequence Number (SN) length of the UE to a predetermined bit length;
after sending the first reconfiguration message, sending, by the wireless base station, a handover request message or a handover required message to inform the target base station, and receiving a handover request acknowledge message or a handover command message by the wireless base station; and
after receiving the handover request acknowledge message or the handover command message by the wireless base station, sending, by the wireless base station, a second reconfiguration message to the UE, wherein the second reconfiguration message includes a handover message.

2. The handover method according to claim 1, wherein after the wireless base station decides to indicate the UE to handover to the target base station based on a measurement report from the UE, the wireless base station sends the first reconfiguration message to the UE.

3. The handover method according to claim 1, wherein the predetermined bit length is 12 bits.

4. The handover method according to claim 1, wherein after the wireless base station determines that the PDCP SN length of the UE is larger than the predetermined bit length, the wireless base station sends the first reconfiguration message to the UE.

5. The handover method according to claim 1, wherein the step of sending the first reconfiguration message to the UE for changing the PDCP SN length of the UE to the predetermined bit length includes:
based on the first reconfiguration message, releasing a Data Radio Bearer (DRB) resource and re-establishing the DRB resource by the UE, wherein a DRB ID used by the UE in re-establishing the DRB resource is different or the same to the DRB ID used by the UE before re-establishing, and the UE uses the same Evolved Packet System Bearer (EPS Bearer) ID.

6. A handover method for a wireless base station, the wireless base station being configured for wireless communicating with a user equipment (UE) and exchanging message with a target base station, the handover method including:
sending, by the wireless base station, a handover request message or a handover required message to inform the target base station that the UE does not used an extended Sequence Number (SN) length in a PDCP layer and to inform the target base station that the UE has a candidate DRB ID;
receiving a handover request acknowledge message or a handover command message by the wireless base station, and based on the handover request acknowledge message or the handover command message, determining by the wireless base station whether a DRB resource of the UE is released or not and whether a configuration of the UE is reset or not; and
when the wireless base station determines that the DRB resource of the UE is not released and that the configuration of the UE is not reset, sending by the wireless base station a first reconfiguration message to the UE for changing a PDCP SN length of the UE to a predetermined bit length and for changing a DRB ID of the UE as the candidate DRB ID, wherein the first reconfiguration message includes a PDCP reconfiguration message and a handover message.

7. The handover method according to claim 6, wherein after the wireless base station decides to indicate the UE to handover to the target base station based on a measurement report from the UE, the wireless base station sends the handover request message or the handover required message.

8. The handover method according to claim 6, wherein the predetermined bit length is 12 bits.

9. The handover method according to claim 6, wherein before the UE receives the first reconfiguration message, the PDCP SN length of the UE is larger than the predetermined bit length.

10. The handover method according to claim 6, wherein the step of sending the first reconfiguration message by the wireless base station to the UE for changing the PDCP SN length of the UE to the predetermined bit length and for changing the DRB ID of the UE as the candidate DRB ID includes:
based on the first reconfiguration message, releasing a Data Radio Bearer (DRB) resource and re-establishing the DRB resource by the UE, wherein a DRB ID used by the UE in re-establishing the DRB resource is different or the same to the DRB ID before re-establishing, and the UE uses the same Evolved Packet System Bearer (EPS Bearer) ID.

11. The handover method according to claim 6, wherein the step of determining by the wireless base station whether the DRB resource of the UE is released or not includes: based on whether the handover command within the handover request acknowledge message or the handover command message includes drb-ToReleaseList IE, determining by the wireless base station about whether the DRB resource of the UE is released or not.

12. The handover method according to claim 6, wherein the step of determining by the wireless base station whether the configuration of the UE is reset or not includes: determining by the wireless base station whether the handover command within the received handover request acknowledge message or the handover command message includes fullConfig-r9 IE or not.

13. A wireless base station exchanging message with a target base station, the wireless base station including:
at least one antenna for wireless communication with a user equipment (UE) and the target base station; and
a controller coupled to the at least one antenna, the controller being configured for:
controlling the at least one antenna to send a first reconfiguration message to the UE, wherein the first reconfiguration message includes a Packet Data Convergence Protocol (PDCP) reconfiguration message for changing a PDCP Sequence Number (SN) length of the UE to a predetermined bit length;
after controlling the at least one antenna to send the first reconfiguration message, controlling the at least one antenna to send a handover request message or a handover required message to inform the target base station, and to receive a handover request acknowledge message or a handover command message; and
after controlling the at least one antenna to receive the handover request acknowledge message or the handover command message,
controlling the at least one antenna to send a second reconfiguration message to the UE, wherein the second reconfiguration message includes a handover message.

14. The wireless base station according to claim 13, wherein after the controller decides to indicate the UE to handover to the target base station based on a measurement report from the UE, the controller controls the at least one antenna to send the first reconfiguration message to the UE.

15. The wireless base station according to claim 13, wherein the predetermined bit length is 12 bits.

16. The wireless base station according to claim 13, wherein after the controller determines that the PDCP SN length of the UE is larger than the predetermined bit length, the controller controls the at least one antenna to send the first reconfiguration message to the UE.

17. The wireless base station according to claim 13, wherein when the controller controls the at least one antenna to send the first reconfiguration message to the UE for changing the PDCP SN length of the UE to the predetermined bit length, based on the first reconfiguration message, the UE releases a Data Radio Bearer (DRB) resource and re-establishes the DRB resource, and a DRB ID used by the UE in re-establishing the DRB resource is different or the same to the DRB ID before re-establishing, and the UE uses the same Evolved Packet System Bearer (EPS Bearer) ID.

18. A wireless base station being configured for exchanging message with a target base station, the wireless base station including:
at least one antenna for wireless communicating with a user equipment (UE) and the target base station; and
a controller coupled to the at least one antenna, the controller being configured for:
controlling the at least one antenna to send a handover request message or a handover required message to inform the target base station that the UE does not used an extended Sequence Number (SN) length in a PDCP layer and to inform the target base station that the UE has a candidate DRB ID;
controlling the at least one antenna to receive a handover request acknowledge message or a handover command message, and based on the handover request acknowledge message or the handover command message, determining whether a DRB resource of the UE is released or not and whether a configuration of the UE is reset or not; and
when the controller determines that the DRB resource of the UE is not released and that the configuration of the UE is not reset, controlling the at least one antenna to send a first reconfiguration message to the UE for changing a PDCP SN length of the UE to a predetermined bit length and for changing a DRB ID of the UE as the candidate DRB ID, wherein the first reconfiguration message includes a PDCP reconfiguration message and a handover message.

19. The wireless base station according to claim 18, wherein after the controller decides to indicate the UE to handover to the target base station based on a measurement report from the UE, the controller controls the at least one antenna to send the handover request message or the handover required message.

20. The wireless base station according to claim 18, wherein the predetermined bit length is 12 bits.

21. The wireless base station according to claim 18, wherein before the UE receives the first reconfiguration message, the PDCP SN length of the UE is larger than the predetermined bit length.

22. The wireless base station according to claim 18, wherein when the controller controls the at least one antenna to send the first reconfiguration message to the UE for changing the PDCP SN length of the UE to the predetermined bit length and for changing the DRB ID of the UE as the candidate DRB ID, based on the first reconfiguration message, the UE releases a Data Radio Bearer (DRB) resource and re-establishes the DRB resource, wherein a DRB ID used by the UE in re-establishing the DRB resource is different or the same to the DRB ID before re-establishing, and the UE uses the same Evolved Packet System Bearer (EPS Bearer) ID.

23. The wireless base station according to claim 18, wherein when the controller determines whether the DRB resource of the UE is released or not, based on whether the handover command within the handover request acknowledge message or the handover command message includes drb-ToReleaseList IE, the controller determines whether the DRB resource of the UE is released or not.

24. The wireless base station according to claim 18, wherein when the controller determines whether the configuration of the UE is reset or not, the controller determines whether the handover command within the received handover request acknowledge message or the handover command message includes fullConfig-r9 IE or not.
